(19) United States
(12) Patent Application Publication
(10) Pub. No.: US 2018/0341033 A1
(43) Pub. Date: Nov. 29, 2018

(54) MODULAR SEISMIC NODE

(71) Applicant: ION Geophysical Corporation, Houston, TX (US)

(72) Inventors: André W. Olivier, River Ridge, LA (US); Lawrence Philip Behn, Houston, TX (US)

(21) Appl. No.: 15/988,668

(22) Filed: May 24, 2018

Related U.S. Application Data
(60) Provisional application No. 62/511,105, filed on May 25, 2017.
(60) Provisional application No. 62/527,646, filed on Jun. 30, 2017.

(51) Int. Cl. G01V 1/18; G01V 1/38

(52) U.S. Cl. CPC G01V 1/186; G01V 1/3808; G01V 1/3852

(57) ABSTRACT

A seismic node assembly includes a power source and a seismic sensor, e.g., with the power source disposed in a power source module and the seismic sensor disposed in a sensor module. A coupling can be defined by selective engagement between the power source (or power source module) and the sensor (or sensor module), with the power source electrically coupled to the seismic sensor, or a singular housing can be used. The seismic sensor is configured for acquiring seismic data when deployed to a seismic medium, and an acoustic transponder or wireless transceiver can be adapted for communicating command and clock signals during deployment and retrieval, or when the node is operationally deployed to the seismic medium.

### CROSS-REFERENCE TO RELATED APPLICATION

This application claims priority to U.S. Provisional Patent Application No. 62/511,105, filed May 25, 2017, entitled MODULAR SEISMIC NODE, and U.S. Provisional Patent Application No. 62/527,646, filed Jun. 30, 2017, entitled MODULAR SEISMIC NODE, each of which is incorporated by reference herein, in the entirety and for all purposes.

### BACKGROUND

This application relates generally to geophysical exploration, and more specifically to seismic data acquisition and sensor technologies. In particular, the application relates to sensor systems for marine seismic surveys, including, but not limited to, ocean bottom cables, autonomous seismic nodes, and towed node systems.

Petrochemical products are ubiquitous in the modern economy, and can be found in everything from oil and gasoline to medical devices, children's toys, and a wide range of everyday household items. To meet the continuing demand for these products, oil and gas reserves must be accurately located and surveyed, so that these important resources can be effectively managed. As a result, there is an ongoing need for new seismic sensor systems and more advanced exploration technologies.

Scientists and engineers typically utilize seismic wave-based exploration to locate new oil and gas reservoirs, and to survey and manage existing reserves over time. Seismic surveys are performed by deploying an array of seismic sensors or receivers over the region of interest, and monitoring the response to controlled emission of seismic energy via a seismic source such as a vibrator, air gun array, or explosive detonation. The response depends upon the seismic energy reflected from mineral reservoirs and other subsurface formations, allowing an image of the corresponding structures to be generated.

Conventional marine seismic surveys typically proceed by towing an array of seismic sensors or receivers behind a survey vessel, with the receivers distributed along one or more streamer cables. A set of air guns or other seismic sources is used to generate the seismic energy, which propagates down through the water column to penetrate the ocean floor (or other bottom surface). A portion of the seismic energy is reflected from subsurface structures, and returns through the water column to be detected in the streamer array. Alternatively, seismic receivers can also be disposed along an ocean-bottom cable, or provided in the form of individual, autonomous seismic nodes distributed on the seabed.

Seismic receivers include both pressure sensors and particle motion detectors, which can be provided as individual sensor components or combined together with both sensor types provided in close proximity within a receiver module or seismic node. For example, a set of pressure sensors can be configured in a hydrophone array, and adapted to record scalar pressure measurements of the seismic wavefield propagating through the water column or other seismic medium. Particle motion sensors include accelerometers and geophones, which can provide single-axis or three-dimensional vector velocity measurements that characterize motion of the medium in response to propagating seismic waves.

Geophysical data pertaining to subsurface structures is acquired by observing the reflected seismic energy with an array of such receiver components. The resulting seismic signals can be used to generate an image characterizing the subsurface composition and geology in and around the survey area.

### SUMMARY

This application is directed to a modular seismic node assembly configured for deployment to a water column or other medium through which seismic waves propagate. Depending on embodiment, the node system can include a separable sensor module and power source module, or a single modular node apparatus.

Suitable sensor modules may include at least one seismic sensor configured to generate seismic data responsive to the seismic waves or wavefield, and a clock configured for associating the seismic data with a clock signal or other timing signal. Suitable power modules may include at least one power source and a memory with capacity for storing the seismic data and associated clock signal.

A transponder can also be provided; e.g., an acoustic transponder or wireless transceiver configuration configured for external communication of control signals through the surrounding seismic medium. The node can be operated in a power savings mode, based on a control signal from the transponder.

In some embodiments, the sensor module includes an elongate lobe or axial section extending from a base or frame component, with the at least one seismic sensor. The power source module (or power module) includes one or more elongate lobes or longitudinal sections extending from a second base or frame component, with the at least one power source configured to provide power to the sensor module for operation of the seismic sensor. The node system can be assembled by selectively coupling the sensor and power modules together; e.g., in an axial or longitudinal engagement with the axial section of the sensor module disposed between first and second longitudinal sections of the power module.

The node system can be disassembled by selectively disengaging or decoupling the power module from the sensor module; e.g., following recovery of the node system after seismic data acquisition. In some embodiments, the sensor module can be decoupled from the power module by sliding the axial section out from between the longitudinal sections of the power module, disengaging the modules along the horizontal or longitudinal plane.

A coupling pin mechanism can be provided to engage the two modules; e.g., by manipulating the pin to engage with coupling member of the sensor module. When deployed on a seabed or other surface, the axial and longitudinal sections may be arranged in a generally horizontal plane, with the longitudinal sections of the power module on opposing lateral sides of the seismic node, and the first and second base components on opposite ends. The transponder may be disposed along the longitudinal axis; e.g., in the base component of the sensor module on one end of the node.

This summary is provided to introduce a selection of related technical concepts, which are further described in the detailed description. The summary is not intended to identify key advantages or essential features of the invention, nor to limit the scope of the claims. A more detailed presentation of additional features, details, utilities, and advantages of the claimed subject matter is provided in the following written description, including various representative examples and embodiments of the invention, and as illustrated in the accompanying drawings.

### BRIEF DESCRIPTION OF THE DRAWINGS

FIG. 1 is a perspective view of a modular seismic node system, in an embodiment suitable for use according to the present disclosure.

FIG. 2 is a top section view of the seismic node system, showing an exemplary configuration of the internal components of the sensor module and power source module.

FIG. 3 is an isometric view of the seismic node system, in a jacketed configuration with the sensor module and power source module disengaged.

FIG. 4 is top plan view of the seismic node system.

FIG. 5 is an isometric view of the seismic node system, with the sensor and power source modules engaged inside the jacket housing.

FIG. 6 is a schematic representation of an exemplary seismic survey, in an embodiment suitable for use with one or more modular seismic node systems according to the present disclosure.

FIG. 7A is an isometric view of a modular seismic node system with an attachment mechanism configured for coupling to a rope or cable for deployment in a seismic survey.

FIG. 7B is an isometric view of the modular seismic node system with an alternate attachment mechanism.

FIG. 7C is top section view of the alternate attachment mechanism.

FIG. 7D is a cutaway view of the alternate attachment mechanism, showing the rope or cable.

FIG. 8A is a section view of the modular node with coupling mechanism in a first (disengaged) position.

FIG. 8B is an alternate section view of the modular node, showing the coupling mechanism in a second (engaged) position.

FIG. 8C is a perspective view of a sensor assembly for the modular node, with the coupling mechanism in the first position.

FIG. 8D is a side detail view of the sensor assembly, showing the coupling mechanism in the second position.

FIG. 9A is a side view of the coupling mechanism, in the first position.

FIG. 9B is a side view of the coupling mechanism, in the second position.

### DETAILED DESCRIPTION

In the following, reference is made to embodiments of the invention. It should be understood, however, that the invention is not limited to the specifically described embodiments. Any combination of the following features and elements, as described in terms of the various embodiments, is contemplated to implement and practice the invention.

Although various features of the invention may provide advantages over the prior art, and over other possible solutions to the problems address herein, whether or not such advantages are achieved does not limit the invention to a given embodiment. The following aspects, features and advantages of the invention are merely illustrative, and are not considered elements or limitations of the appended claims, except where explicitly recited therein. Likewise, reference to “the invention” shall not be construed as a generalization of any subject matter disclosed herein, and does not limit the claims except where expressly included.

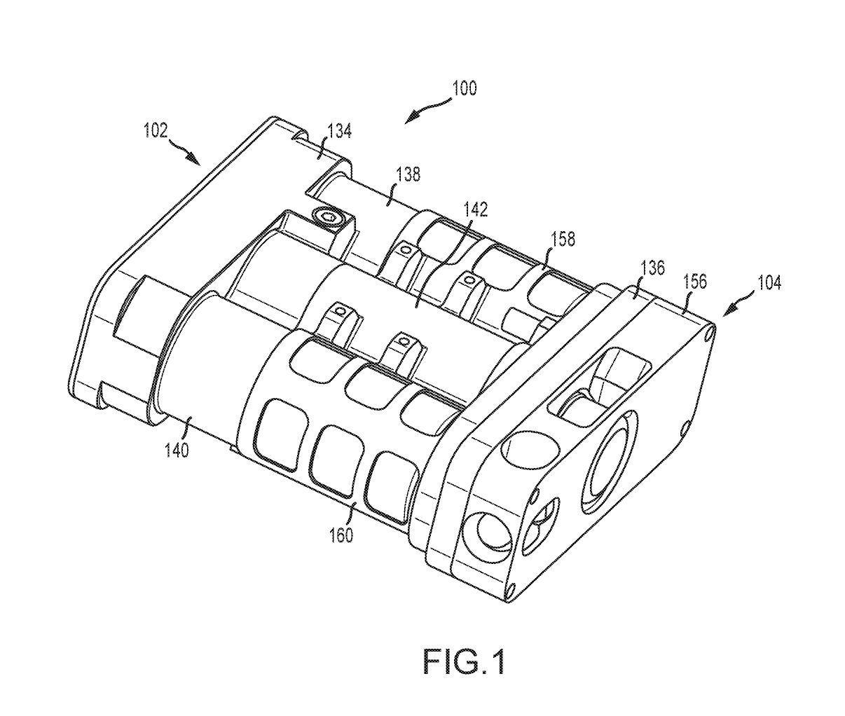

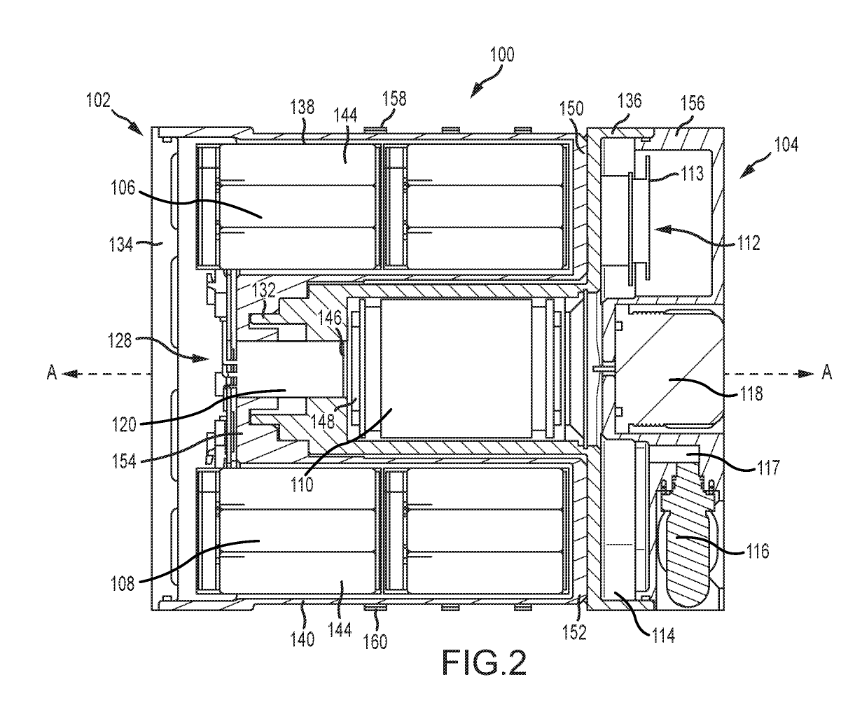

FIG. 1 is a perspective view of a modular seismic receiver or node system 100, in an embodiment suitable for use according to the present disclosure. FIG. 2 is a top section view of the seismic node system 100, showing an exemplary configuration of internal components of the power source module 102 and sensor module 104.

As shown in FIGS. 1 and 2, the modular seismic node system (or node assembly) 100 includes a power source module (or power module) 102 configured for selective engagement with a sensor module 104. The power module 102 includes a power source 144 comprising one or more individual batteries, battery packs, power supplies, power assemblies, or other power source components 106, 108.

The sensor module 104 includes one or more seismic sensors 110 configured to generate seismic data responsive to a seismic wavefield; e.g., a multi-axis geophone, accelerometer, particle motion sensor or other suitable sensor device configured to provide vector output that characterizes particle motion. Depending on embodiment, the seismic sensor or sensors 110 may comprise a multi-axial sensor device, for example a triaxial vector sensor configured to provide vector output responsive to three independent spatial components of particular motion associated with seismic waves propagating in a seismic medium. Additionally or alternatively, the seismic sensor or sensors 110 may comprise a single-axis sensor configured to provide output responsive to motion along a single axis, for example a substantially vertical axis as defined by the orientation of the seismic node system 100 when deployed with respect to a seismic medium for acquiring seismic data. Additional sensor devices can also be used, for example a tiltmeter, magnetometer, compass, or other devices configured to generate a signal responsive to the position and orientation of the seismic node system 100.

For example, the sensor module 104 may also include a hydrophone or other suitable pressure sensor 116 configured to provide scalar output responsive to pressure measurements of the acoustic component in a seismic wavefield propagating through the surrounding water column. In some embodiments, the sensor module 104 includes both a three-component seismic motion sensor 110 and a hydrophone 116, providing a four-component (4C) seismic node system 100. For example, a hydrophone or similar acoustic pressure sensor 116 may be disposed in the base section of sensor module 104, proximate a geophone-type seismic motion sensor 110, and signals from the geophone and the hydrophone can be combined to reduce ghosting in the seismic data output.

In addition to the seismic motion sensor 110 and acoustic pressure sensor 116, the modular seismic node assembly 100 may also include a number of additional geophones, hydrophones, accelerometers, velocity sensors, and the like. In such embodiments, the additional sensors may be provided within the sensor module 104, and configured for measuring acoustic pressure, linear motion, rotation, or a combination thereof. Suitable sensor devices also include both analog and digital designs, including, but not limited to, differential pressure sensors, micro electro-mechanical system (MEMS) accelerometers, and multi-axial particle motion sensors configured for measuring a combination of linear and rotational motion with respect to three independent axes.

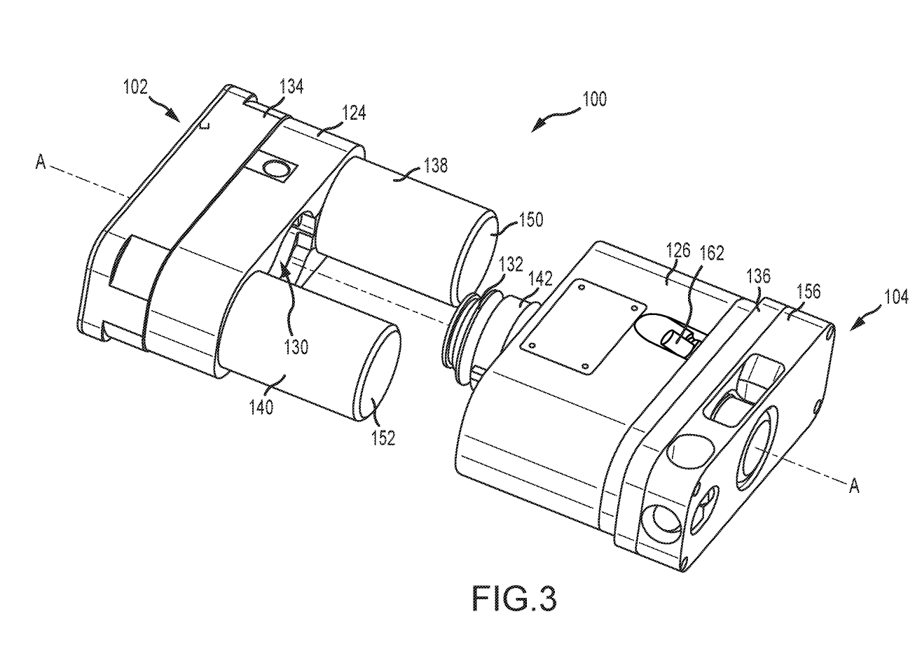

FIG. 3 is an isometric view of the seismic node system 100, in a jacketed configuration with the power module (or battery assembly) 102 and sensor module (or sensor assembly) 104 disengaged. As shown by comparing FIG. 3 to FIG. 1, the modular seismic node assembly 100 can be assembled by selectively coupling the sensor module 104 and the power module 102 together; e.g., in an axial or longitudinal engagement with the axial section 142 of the sensor module 104 disposed along a principal longitudinal axis A of the assembled seismic node system 100, between the first and second longitudinal, laterally disposed sections 138, 140 of the power module 102.

When deployed on a seabed or other surface S, the axial section 142 of the sensor module 104 and the longitudinal power module sections 138, 140 may be arranged in a generally horizontal plane, with the longitudinal sections 138, 140 of the power module 102 disposed on opposing lateral sides of the assemble seismic node system 100, and with the first and second base components on opposite ends of the longitudinal axis A. In some embodiments, a transponder 118 may be disposed along the longitudinal axis A; e.g., coupled to a transponder driver 114 mounted to a chassis or base frame structure 136 of the sensor module 104, on the proximal end of the assembled node system 100, or opposite the memory board 128 in the base component of the power supply module 102, on the distal end of the assembled node system 100.

The modular seismic node assembly 100 can be disassembled by selectively disengaging or decoupling the power module 102 from the sensor module 104; e.g., following recovery of the node system 100 after seismic data acquisition in a seismic survey. In some embodiments, the sensor module 104 can be decoupled from the power module 102 by sliding the axial section 142 of the sensor module 104 out from between the laterally disposed sections 138, 140 of the power module 102, disengaging the modules 102 and 104 along the primary axis A of the node system 100.

The longitudinal power module sections 138, 140 form housings for the respective power source components 106, 108, and the central sensor section 142 forms a housing for the seismic motion sensors 110. When the power module 102 and sensor module 104 are selectively engaged or coupled together, the power source 144 can be electrically connected to the sensor module 104, with one or more battery packs, power assemblies, or other individual power sources 106, 108 configured to provide operational power to the seismic motion sensors 110 and other internal sensor module components.

For example, a data acquisition system 112 can also be provided in the sensor module 104, and configured for recording seismic data collected by the seismic motion sensor(s) 110 and acoustic pressure sensor 116, and other sensor devices. Suitable seismic data acquisition systems 112 may also include a data acquisition board or circuit with a combination of random access memory and non-volatile (or non-transient) data storage media with sufficient capacity to record the substantial amounts of seismic data that may be obtained during a seismic survey. While the seismic data acquisition system 112 is shown as a single component, it should be understood that suitable seismic data systems 112 may comprise a plurality of memory components or modules operating at different access levels, ranging from high-speed registers and caches to lower-speed, DRAM chips and other high capacity data storage media. In some embodiments, the memory board 128 may be mounted on the power supply module 102; e.g., on the base 134 between the first and second longitudinal sections 138, 140 (see FIG. 2).

The data acquisition system 112 may also include a timing device or clock circuit 113. In some embodiments, the timing circuit or clock 113 can be configured to independently generate a clock signal for the seismic sensor station, where the clock signal is associated with the acquired seismic data for storage in the data acquisition system 112. For example, the timing device or clock 113 may incorporate a chip scale atomic clock (CSAC) or similar highly accurate clock component. In some embodiments, the timing device or clock 113 may be configured to receive an external clock signal from a master clock, and to generate a local or slave clock signal that is synchronized with the external master clock signal to provide improved timing accuracy for the seismic data acquired by the seismic node system 100.

In some embodiments a transponder 118 can be provided for external communications; e.g., with a remote processor or control system on board a seismic vessel, or on a surface buoy or unmanned autonomous vessel. For example, a suitable acoustic or wireless transponder 118 may be configured to communicate information indicative of the position, orientation, and operational condition of the seismic node system 100, such as the location, tilt, and power condition of the seismic node system 100. Alternatively or in combination, transponder 118 can also be configured for peer-to-peer communications with other seismic nodes 100 deployed in a seismic survey.

The transponder 118 is configured for transmitting and receiving external control communications through the surrounding water column (or other seismic medium) when the seismic node system is deployed on the ocean bottom, and for wireless control communications before or during deployment to the ocean bottom, or during or following recovery of the seismic node system 100. For example, a remote processor or control system can be configured to transmit a “ping” signal or similar acoustic or inductive query or command signal to the deployed seismic node system 100, on the ocean bottom, and the transponder 118 can transmit a responsive command signal back to the remote system; e.g., indicating the location, tilt and other operational conditions of the seismic node system 100.

Depending on embodiment, data acquisition commands are also transmitted to the deployed seismic system 100 on the ocean bottom, for example a start command when seismic data are to be acquired, and a stop or sleep command when seismic data acquisition is completed. The use of transponder 118 for external control communications may thus be advantageous for autonomous configuration of the seismic node system 100, in order to increase positional accuracy and to provide for power saving options when node system 110 is deployed a period of time between active seismic surveys. The command signals can be exchanged though the seismic medium, e.g. using an acoustic transponder 118, or through the air, using a radio frequency (RF) transponder or transceiver 162, or a combination of acoustic and RF transponders 118 and transceivers 162.

An antenna, such as a radio frequency (RF) antenna or other wireless transmitter or transceiver 162, can be provided on or within an aperture on the jacket assembly 122 and coupled to the power module 102 or sensor module 104, and configured to communicate with the node 100. The antenna or wireless transmitter 162 can derive power from the power module 102 when the node 100 is coupled together, and communicate data and/or control information between the node 100 and a survey control or data collection system; e.g., on board a seismic vessel. For example, the antenna 162 can be used to synchronize the node clock 113 to a master clock just prior to deployment, and to compare the node clock 113 to the master clock upon recovery, in order to determine the relative clock drift. Two or more antennas 162 may be incorporated into the design, for 360 degree coverage.

Additional commands can be provided for the node 100 to power on and off, or to reduce power consumption, by transmitting RF signals to one or both of the transponder 118 and the antenna or transceiver 162 for transmission to the power source 144, or to other components such as the clock 113 or data acquisition system 112, or to sensors 110 and related signal processing components. In some embodiments, the antenna 162 communicates a time stamp or other clock information with the internal clock inside the node 100, for example a timing signal used for clock synchronization or for correction of clock drift. For example, antenna 162 can be used to simultaneously read the node clock 113 and the master clock on the seismic vessel just after retrieval, and compare the two clocks to record the difference or offset. The RF link established by antenna 162 will be able to accomplish this as the node 100 leaves the water column, before reaching the ship. More generally, the transponder 118 and RF antenna or wireless transceiver 162 can be used for communicating any suitable data and/or selected commands to and from the respective internal component of each node 100.

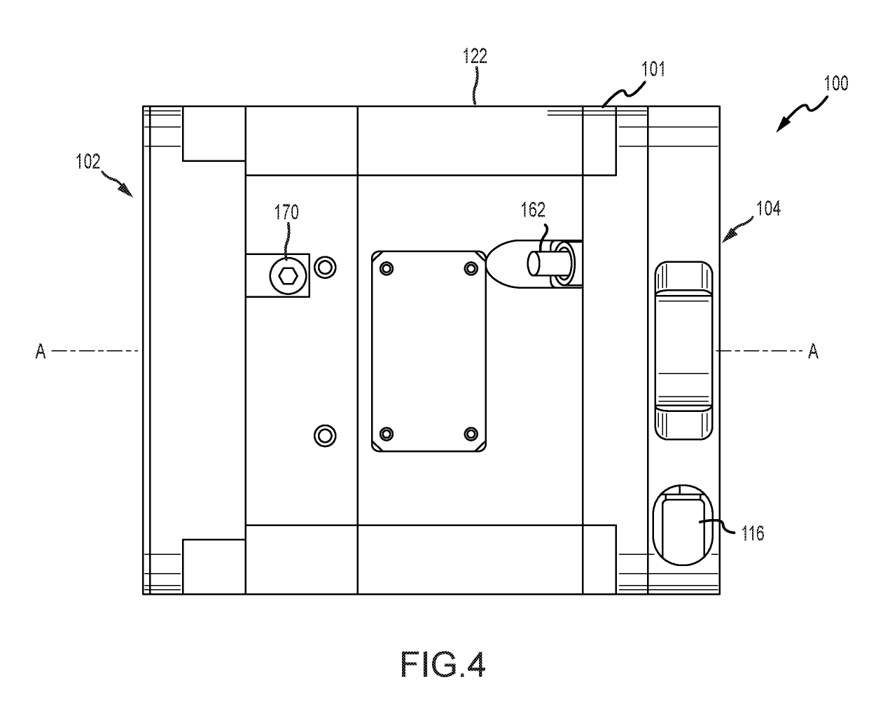

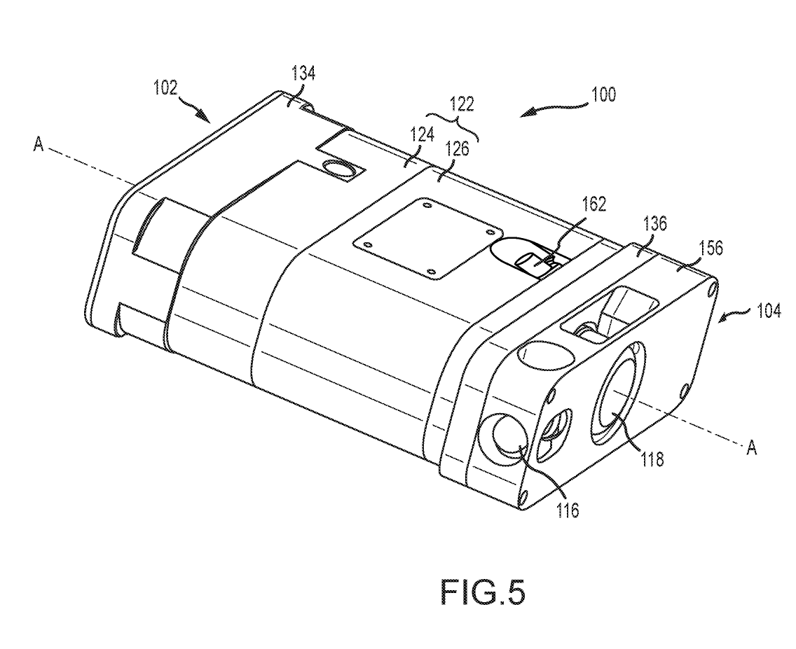

FIG. 4 is top plan view of the seismic node system 100. FIG. 5 is an isometric view, showing the sensor module 104 and power source module 102 engaged inside the jacket housing assembly 122.

In particular embodiments according to FIGS. 1-5, the seismic motion sensors 110, seismic data acquisition system 112, clock 113, transponder 118, and hydrophone or pressure sensor 116 are each disposed within the housing of the sensor module 104, while the individual batteries or other components 106, 108 of the power source 144 are disposed within the housing of the power source module 102, with memory board 128. Thus, all or substantially all of the sensing, communication, and data acquisition components of the seismic node system (or sensor station) 100 may be provided with the sensor module 104, while all or substantially all of the power source components may be provided with the power source module 102, along with memory for storing the seismic data and associated clock signals. This arrangement can facilitate easier, more efficient replacement of the battery packs or other power sources 106, 108, and recovery of the seismic data; e.g., by simply separating the power source module 102 from the sensor module 104, or exchanging power source module 102 with a replacement, and then extracting the data and recharging the batteries or other power source components 106, 108.

Suitable seismic node systems 100 can also be provided within a singular modular housing 101, including the internal components of the power source module 102 and sensor module 104 in a substantial unitary modular node apparatus 100. Alternatively, one or more the internal components may be provided within either the power source module 102 or the sensor module 104; e.g., the transponder 118 and/or transceiver 162. In some embodiments, additional components such as memory board 128 may be mounted on the base 134 of the power module 102; e.g., between the first and second longitudinal sections 138, 140. A jacket 122 and engagement mechanism 170 may also be provided, as described below.

As shown in FIGS. 1-5, the power source 144 can include one or more battery packs or similar power source components 106, 108 configured to provide power to the data acquisition and recorder system 112, clock 113, transponder driver 114, seismic motion sensors 110, acoustic pressure sensor 116, and other electronic components of the modular seismic node assembly 100, for the duration of a particular seismic survey. In some embodiments, a memory board 128 may be mounted on the power supply module 102. In other embodiments, external power may also be provided to the seismic node system 100; e.g., via a cable or inductive coupling to power source module 102, or otherwise as described herein.

In some embodiments, the seismic node system 100 can include one or more depth sensors or static pressure transducers 117, either independently or in combination with the acoustic pressure sensor 116. For example, a suitable depth or static pressure transducer 117 can be configured to determine a depth of the seismic sensor station or node within a water column during deployment and/or retrieval. In one such embodiment, a preselected threshold depth can be defined for selectively powering individual components of the seismic sensor system 100, for example one or both of the data acquisition system 112 and clock 113, one or more of the sensors 110, 116, or a combination thereof.

During deployment, for example, one or more of the sensors 110, 116, the data acquisition system 112, the clock 113, and other electronically powered components of the seismic node system 100 can be operated in an unpowered or low-power “sleep” (inactive) state until a threshold depth is reached, as measured by a depth sensor or similar static pressure transducer 117 provided on the sensor module 104. Then, one or more of the components can be switched to an “awake” or active state for seismic data acquisition, once the threshold depth has been reached. Similarly, one or more of the electronic components 110, 112, 113, 116 of the seismic sensor system 100 may also be powered down during retrieval; e.g., when the seismic node system 100 is recovered to a depth less than the preselected threshold. Depending on memory configuration power to the memory board 128 may be maintained in the sleep state, in order to preserve the seismic data for recovery. Data can be recovered from the memory board 128 with the power module 102 and sensor module 104 coupled together, or after decoupling the modules 102, 104, with the power source 144 electrically decoupled from the seismic sensor 110, and the other internal components of sensor module 104.

By selectively powering the various internal circuits of the sensor module 104, the seismic node system 100 may thus conserve power, and extend the operational life of the seismic sensor system 100 for improved seismic data acquisition capability. Alternatively, such a static pressure or depth sensor may be provided within either the sensor module 104 or the power supply module 102 in operational communication with a power supply module controller, in order to regulate the power supplied to the sensor module 104 as a unit. Power management can also be provided via commands received by the transponder 118.

As shown in FIGS. 3-5, the power and sensor modules 102, 104 are configured to detachably couple to one another to form a complete, assembled seismic node system 100. In this particular example, the power module 102 contains a power source 144 with a number of battery packs or other individual power source components 106, 108, and the sensor module 104 includes a seismic motion sensor 110 and other electronic components.

Depending on embodiment, the power module 102 can thus be configured to connect with the sensor module 104 to electrically couple the power source 144 with the seismic motion sensors 110. For example, the seismic node system 100 may be configured so that the power and sensor modules 102, 104 couple mechanically at an interface proximate the seismic motion sensors 110; e.g., where the interface provides an electrical connection joining the individual power sources 106, 108 to the seismic motion sensors 110 and other internal electronic components of the sensor module 104. This modular configuration places the power source 144 and seismic sensors 110, 116 in different cases or compartments defined within separate power and sensor modules 102, 104, and improves on other designs where the hydrophones, geophones or other seismic sensors are disposed in the same case or compartment as the power supply, with or without one or more additional components such as the clock and data recorder, and they cannot be decoupled for separate storage and maintenance. Power, electrical, and data connections are provided between the separate, decouplable sensor and power modules 102, 104. The connections are provided when the separate modules or packages 102, 104 are coupled together, allowing the modules to operate together to collect seismic data when deployed to the seabed or ocean bottom, and then be decoupled for separate storage and maintenance. This improves on designs where the seismic sensor and power source components are provided in a single, self-contained case or package, or in a similar internal compartment, without suitable connections that allow the power supply and seismic sensor packages to be decoupled. Similarly, designs where the power and seismic sensor elements are disposed within the same internal compartment cannot be easily decoupled, because all the electrical connections between these elements are contained within the same compartment of case, and cannot be disconnected into separate, modular power and sensor packages 102, 104.

In some embodiments, the power and sensor modules 102, 104 selectively engage or couple to form a seismic node system 100 that is generally symmetrical about a longitudinal axis A, extending along the central section 142 of the sensor module 104, between the laterally disposed longitudinal sections 138, 140 of the power module 102. For example, the assembled seismic node system 100 may have a generally bilateral or reflexive symmetry about the central axis A, with the center of gravity disposed approximately in the middle of the axis. In these examples, a multi-axis geophone or similar seismic motion sensor 110 can be disposed approximately at the center of mass, approximately coaxially oriented within the central sensor module section 142.

As shown in the figures, the power and sensor modules 102, 104 may couple to one another in sliding engagement along the longitudinal axis A. For example, the power and sensor modules 102, 104 may couple to one another by sliding the axial section 142 of the sensor module 104 longitudinally along axis A of the seismic node system 100, between the longitudinal sections 138, 140 of the power module 102, so that the respective power module sections 138, 140 are disposed on opposite lateral sides of the axial sensor module section 142 in the assembled sensor node system 100.

In some embodiments, a coupling member or connector 132 extends from the axial section 142 of the sensor module 104, and is configured to selectively engage with a complementary mating connector 120 extending from the base 134 of the power module 102, inside receiving aperture 130. Depending on application, the power module connector 120 can be provided with a jack or similar power module interface 146 configured to connect with a complementary sensor module interface 148 inside the sensor module connector 132, in order to form electrical connections between the power sources 106, 108 and the various internal electronic components 110, 112, 113, 114, 116, 117, 188 of the sensor module 104. Suitable mechanical connectors 120 and 132 may also provide water-tight and pressure tight connections between the power module 102 and the sensor module 104, in order to protect the internal components from seawater, pressure, dirt, and other potentially adverse operational effects and environmental conditions.

Structurally, the power module 102 may include a base or frame member 134 extending generally transversely to the longitudinal axis A of the assembled seismic node system 100, between the longitudinal sections 138, 140. The power module sections 138, 140 extend longitudinally from the base or chassis member 134; e.g., generally parallel to the principal axis A, and transversely disposed on either side of the axial section 142 of the sensor module 104. In some embodiments, additional components of the power source 144, such as battery memory board 128, may be mounted on the base 134; e.g., between the first and second longitudinal sections 138, 140. The power module connector 120 extends from the base or frame 134 along axis A, between the laterally disposed sections 138, 140.

In some embodiments, battery packs or other power source components 106, 108 are housed within respective longitudinal sections 138, 140 of the power module 102. The longitudinal sections 138, 140 can be integrally formed with the power module base member 134, or attached by welding or other mechanical attachment to a similar transverse component 134. In one particular configuration, the individual power source components 106, 108 and corresponding longitudinal sections 138, 140 each have a generally cylindrical, elongated geometry, with the power source components 106, 108 extending inside longitudinal sections 138, 140 from the transverse base member 134 to the respective ends 150, 152 of the power module housing.

The sensor module 104 includes a frame structure 136 extending transversely with respect to the longitudinal axis A. The central sensor section 142 extends longitudinally from the transverse sensor module frame structure 136, along the central axis A, with the seismic motion sensors 110 housed inside. The axial section 142 of the sensor module 104 may be integrally formed with the sensor module frame 136, or they can be formed separately and mechanically attached. The frame 136 of the sensor module 104 may have a height and width approximately similar to or substantially the same as that of the power module base 134, in order to provide a substantially symmetrically dimensioned seismic node system 100. For example, the axial section 142 may extend longitudinally along the central axis A, approximate from the middle of the sensor module frame structure 136, so that the axial section 142 is symmetrically disposed between the longitudinal sections 138, 140 of the power module 102.

In some embodiments, the central sensor module section 142 houses a three-dimensional geophone or similar multi-axis seismic motion sensor 110. The central sensor module section 142 may also have an elongated cylindrical geometry, complementary to that of the longitudinal power module sections 138, 140; e.g., where each housing component 138, 140, 142 of the power module 102 and the sensor module 104 has a generally circular cross section taken perpendicularly to the principal axis A of the assembled seismic node system 100, and the longitudinal or axial sections 138, 140, 142 extend from transverse sections 134, 136, respectively. Alternatively, the longitudinal housing components 138, 140, 142 may have oval, oblong, square, rectangular, or triangular cross sections, or other suitable geometry. The power and sensor modules 102, 104 thus have irregular and complementary housing configurations, which can be joined together to form a generally oblong (e.g., square or rectangular) assembled node system 100. This is different from traditional self-contained, fully enclosed, unitary, or single-housing designs, where the seismic sensor and power components share the same housing or internal compartment, and the power and sensor packages cannot be decoupled because all the connections are contained in the same internal compartment. The complementary module geometry also improves on simpler disk-shaped and plate-based designs (e.g., where the housing is formed by one or more plates joined along a periphery), and the rectangular shape provides for easier handling and increased packing, transport and storage efficiency.

### Module Engagement

In some embodiments, the sensor module 104 includes one or more receiving structures 158, 160, each extending from the sensor module frame structure 136 and configured to engage the respective longitudinal section 138, 140 of the power module 102. For example, the power module sections 138, 140 may be longitudinally engaged within the complementary receiving structures 158, 160 when the power module 102 is axially engaged with the sensor module 104, each longitudinal section 138, 140 entering into sliding engagement within a respective receiving structure 158, 160 on the sensor module 104.

Generally, the power module sections 138, 140 and receiving structures 158, 160 may have complementary cross sectional geometry. For example, the receiving structure 158, 160 can comprise two generally cylindrical cages or sleeves extending from the sensor module frame 136, and configured to receive the power module sections 138, 140 in longitudinal engagement therein. Thus, the receiving structures 158, 160 may be cylindrically shaped and configured to receive complementary cylindrically shaped power module sections 138, 140. Alternatively the geometry may be square, oblong, oval, rectangular or triangular, or the sections 138, 140 can have another suitable geometry as described above.

In some embodiments, the seismic node system 100 is configured so that when the power and sensor modules 102, 104 are engaged, the central sensor module section 142 slides between the lateral power source module sections 138, 140. When the modules 102, 104 are coupled together, the ends 150, 152 of the housing sections 138, 140 are disposed adjacent to or abut the frame or chassis structure 136 of the sensor module 104, within the respective receiving structures 158, 160.

Connector 132 extends from the central sensor module section 142, and is received within an aperture 130 defined in the base 134 of the power module 102. When the modules 102, 104 are coupled, connector 132 is engaged within a receiving structure 154 configured to provide a pressure and fluid-tight seal, as described above. In some embodiments, the receiving structure 154 is integrally formed within aperture 130 of the power module base 134, between the lateral power module sections 138, 140. Alternatively, receiving structure 154 may be separately formed, and mechanically attached to the power module base 134.

The various internal components of the seismic node system 100 can be mounted or attached to the frame structure 136 of the sensor module 104. For example, a geophone or other seismic motion sensor assembly 110 may be disposed within the central or axial section 142 of the power module 102, with other components mounted directly to the pressure module frame 136. While the geophone or seismic motion sensor 110 is mounted on an interior side of the transverse sensor module frame structure 136, other components such as the data acquisition system 112, transponder driver 114, hydrophone or acoustic pressure sensor 116, static pressure transducer 117, and transponder 118 can be mounted to the exterior-facing side, opposite the seismic motions sensors 110 in the central housing section 142.

In these configurations, an outer cover or housing component 156 can be provided to cover and protect the exterior-facing sensor module components. The cover 156 can also be configured to improve hydrodynamic properties of the assembled seismic node system 100, and to provide ports for pressure communication between the water column and pressure-sensitive elements such as the acoustic pressure sensor 116, depth sensor 117, and transponder 118.

When the power and sensor modules 102, 104 are coupled to one another, the assembled seismic node system 100 may have a center of gravity approximately centered along the longitudinal axis A. The seismic motion sensors 110 can also be centered along the longitudinal axis A, approximately at the center of mass location inside the axial sensor module section 142, with the transponder 118 arranged coaxially about axis A at the proximal end.

This arrangement improves symmetry of the assembled seismic node system 100, with the central sensor module section 142 and transponder 118 arranged coaxially about the longitudinal axis A, and the longitudinal power module sections 138, 140 arranged with bilateral symmetry on either side of the axis A and central sensor module section 142. The power module base 134 and sensor module frame 136 can also be arranged with bilateral symmetry about the longitudinal axis A. Similarly, the recorder system 112, transponder driver 114, hydrophone 116 and static pressure transducer 117 can also be distributed generally symmetrically about the longitudinal axis A. Where the mass moments of these components are not substantially balanced across the axis A, trim elements can be added to compensate, so that the center of mass of the assembled node system 100 is maintained along the longitudinal axis A, increasing hydrodynamic stability in the water column during deployment, recovery, and towing operations.

In some embodiments, the seismic node system 100 can include a jacket assembly 122 configured to engage with the node housing 101 to provide a substantially smooth outer wall, in order to improve the hydrodynamic performance the seismic node system 100 and to reduce the risk of contamination of the connectors and other internal components. The jacket assembly 122 may be formed or one or more sections 124, 126; e.g., disposed about the longitudinal power module sections 138, 140 and the axial sensor module section 142, or otherwise arranged toward the distal and proximal ends of a generally rectangular or oblong sensor node system 100.

Alternatively the seismic node system 100 may be provided in unjacketed form, with a round, square, pyramidal or other suitable geometry having various rotational, bilateral or reflexive symmetry properties. Similarly, the seismic node system 100 may also include one or more additional modular components; e.g., as adapted for housing one or more of the data acquisition system 112, transponder driver 114, hydrophone or acoustic pressure sensor 116, static pressure transducer 117, and transponder 118.

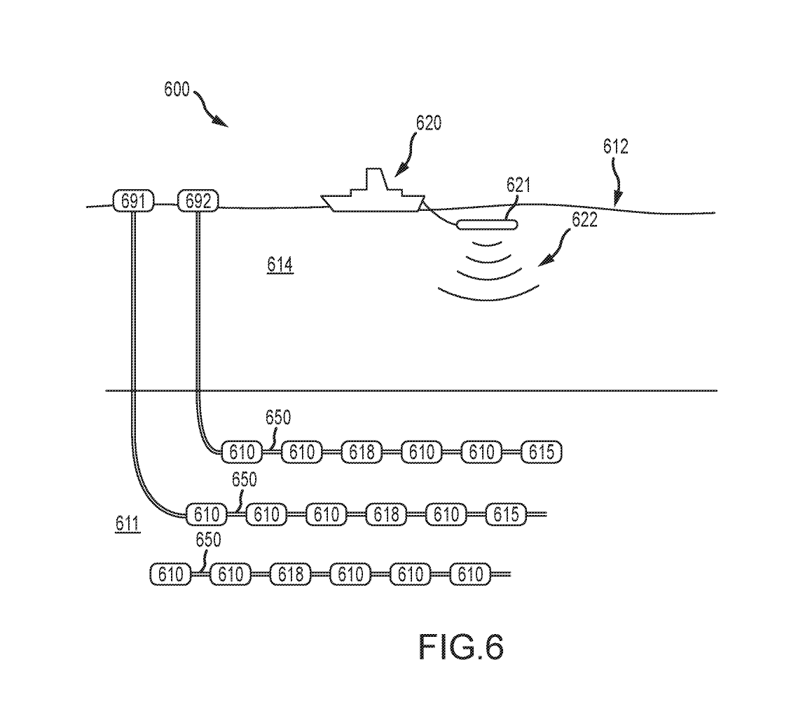

FIG. 6 illustrates an exemplary seismic survey 600 in which seismic nodes 610 are deployed on the bottom surface 611 below a water column 614, for example utilizing an array of modular seismic node systems 100, as described herein. As shown in FIG. 6, a source vessel 620 tows a seismic source 621 beneath the top surface 612 of water column 614, emitting energy in the form of acoustic waves 622 that propagate through the water column 614. Alternatively or in combination, the seismic vessel 620 may tow an array of seismic nodes 610; e.g., an array of modular node systems 100 deployed along one or more ropes or node lines.

The sensor nodes 610 can also be deployed on the bottom surface 611 via a rope or wire 650. Suitable ropes 650 may be made from synthetic materials with predefined specific density selected relative to that of the water column 614, and provided in passive form, without internal electrical conductors. Alternatively, the rope or cable 650 may include embedded conductors for communicating one or more of a clock signal, data signals, control signals and power among the individual seismic sensor stations or nodes 610. Thus, the rope or cable 650 may have either a passive configuration, absent signal or power communications, or an active configuration, in which signal and/or power connections are provided to one or more surface buys or hub devices 691, 692. In embodiments where one or more ropes or cables 650 are configured to transfer power or data signals, a termination device 615 may be provided at an end of or along selected cables 650. In some embodiments, a high precision clock may be included in each seismic node or station 610, or in selected seismic node devices or stations 618 disposed along one or more of the cables 650.

In operation of the seismic survey 600, the source boat or vessel 620 tows the seismic source (or a number of seismic sources 621) in the region of seismic nodes 610. The seismic source 621 can be configured to release blasts of compressed air or other seismic energy into the water column 614, generating acoustic waves 622 propagating towards the bottom surface or seabed 611.

A portion of the seismic energy may penetrate the seabed 611 to reflect from subsurface (or sub-seabed) structures. The reflected energy can be recorded by the seismic nodes 610, and processed to develop images of the subsurface structures. The images can be analyzed to locate hydrocarbon reservoirs and other natural resources, and to identify other geophysical features of interest. While references may be made ocean bottom nodes, the modular node systems described here are not limited to any particular body of water or water column 614, and may be used in any suitable water, marine, or land-based environment, including oceans, seas, lakes, rivers, and in land-based seismic survey applications.

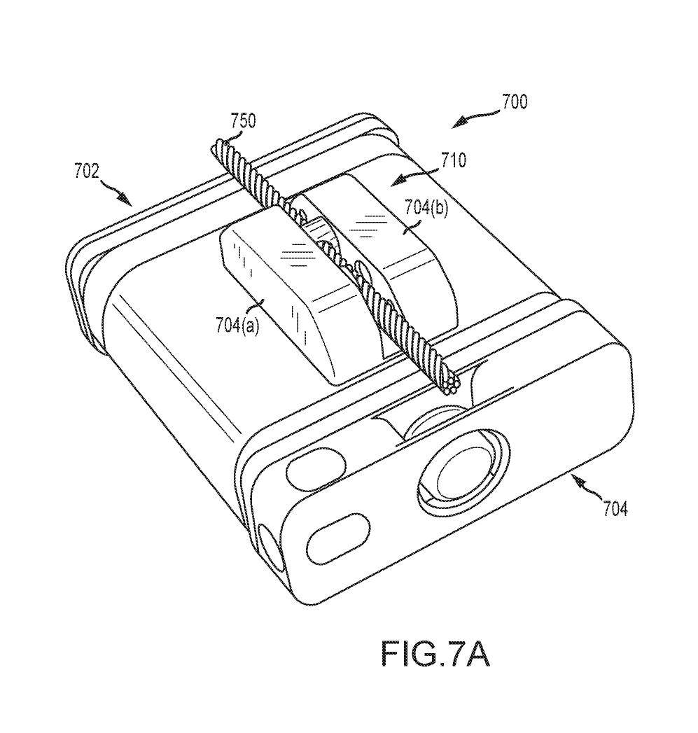

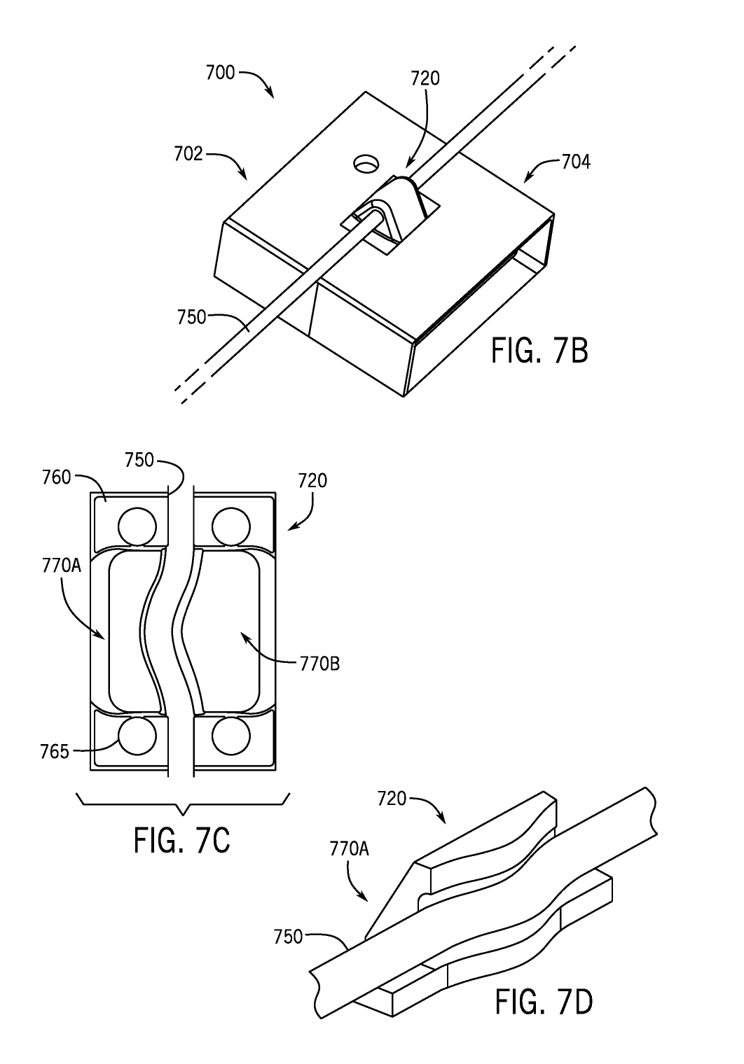

FIG. 7A is an isometric view of a modular seismic receiver system or node assembly 700, e.g. a modular seismic receiver or node assembly 100 or 610, with an attachment system 710 configured for coupling the seismic node system 700 to a rope or cable 750; e.g., with power and sensor modules 702, 704 coupled together for deployment to a water column as described herein. As shown in FIG. 7A, the attachment system 710 may include one or both of first and second coupling mechanisms 704a, 704b disposed on either side of the rope 750. The attachment system 710 can be configured to attach the seismic node system 700 to the rope 750 by various suitable methods, such as with one or more pins, a lever arm, cam, or by similar mechanisms 704a, 704b configured for clamping or otherwise coupling node system 700 to the rope 750.

FIG. 7B is an isometric view of the modular seismic node system 700 with an alternate, capstan-type attachment mechanism 720 for attachment to a rope or cable 750. FIG. 7C is top section view of the alternate attachment mechanism 720, and FIG. 7D is a cutaway view of the mechanism 720, showing the rope or cable 750. As shown in FIGS. 7B-7D, the capstan mechanism 720 includes a base plate 760 attached to the outer surface of seismic node system 700, e.g. via one or more mechanical fastening points 765, with complementary first and second capstan-type coupling members 770A and 770B, positioned on either side of the rope or cable 750.

Mechanism 720 utilizes the mechanical advantage of capstan tensioning for secure attachment of node system 700 to the rope or cable 750, where the maximum tension load T₂ applied to the rope or cable 750 without slipping depends on the holding tension T₁, the coefficient of friction μ between the rope or cable 750 and the capstan 710, and the angle of curvature β defined by the bend of the rope or cable 750 between capstan members 770A and 770B; e.g., according to:

T₂=T₁×e^{μβ}, [1]

where the coefficient of friction μ is a dimensionless quantity and the angle β is in radians.

Because the relationship is exponential, the tension ratio T₂/T₁ changes rapidly with the rope angle β. The geometry and materials of attachment members 770A, 770B and cable 750 can thus be adapted to provide a suitable angle β, with coefficient of friction μ selected to provide a predictable, scalable release tension or translation load release value TLR below the cable safe working limit (SWL); e.g., according to:

TLR=SWL×e^{-μβ}. [2]

Representative ranges for the safe working limit SWL include, but are not limited to, on the order of about 1000 lb (about 4500 N) or less to about 10000 lb (about 45000 N) or more, for example about 5000-6000 lb (about 22000-27000 N). Representative values for the coefficient of friction μ include, but are not limited to, about 0.1 or less to about 0.2 or more, for example about μ=0.15. Representative ranges for the rope angle β include, but are not limited to, about π/4 (45°) or less to about π/2 (90°) or more. In particular embodiments, suitable values of the translation load release TLR may thus range from about 4900 lb (about 22000 N) to about 5400 lb (about 24000 N), for a safe working limit SWL of about 6,000 lb (about 27000 N); e.g., for a coefficient of friction μ of about 0.15, and a rope angle β of about 0.75 rad (or about π/4) to about 1.5 rad (or about π/2).

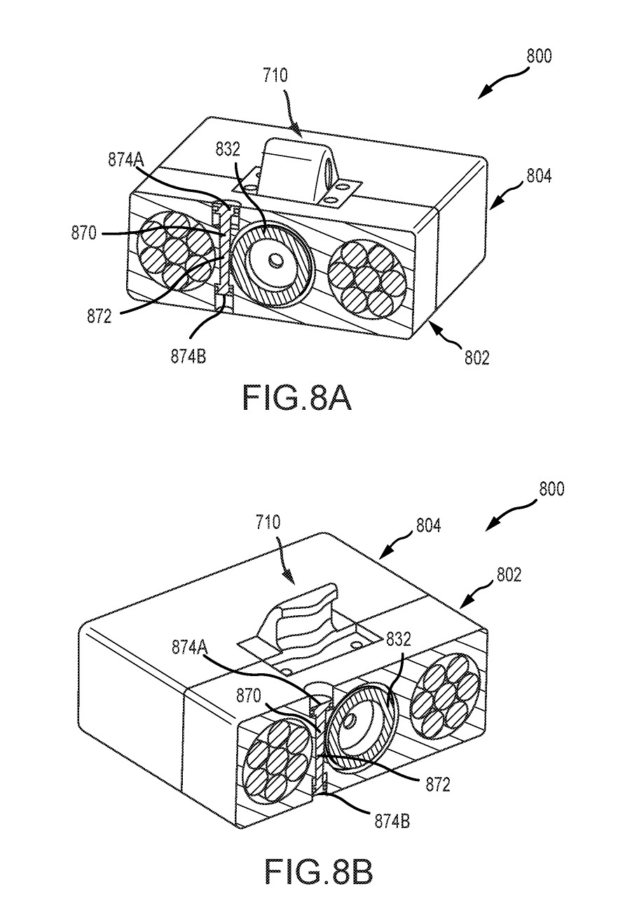

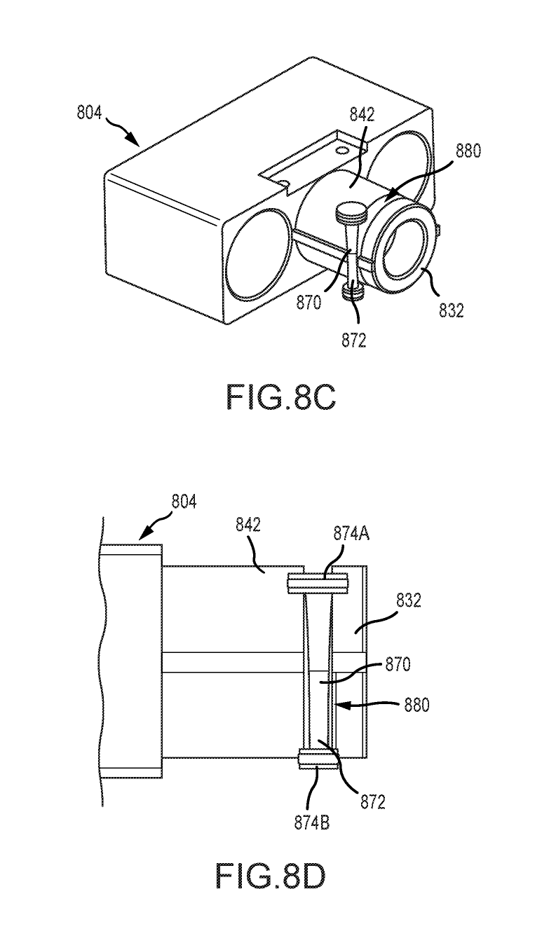

FIG. 8A is a section view of a modular seismic node system 800; e.g., a modular seismic receiver or node assembly 100, 610 or 700 as described herein, showing a coupling or engagement mechanism 870 in a first position; e.g., for decoupling power module 802 from sensor module 804. FIG. 8B is an alternate section view of the modular node 800, showing the engagement mechanism 870 in a second position; e.g., for selectively coupling power module 802 to sensor module 804.

FIG. 8C is a perspective view of a sensor assembly or sensor module 804 for the modular node 800, showing the engagement mechanism 870 in the first (disengaged or unlocked) position. FIG. 8D is a side detail view of the sensor assembly 804, with the engagement mechanism 870 in the second (engaged or locked) position. Alternatively, the first and second positions can be interchanged; e.g., for engaging and disengaging the power and sensor modules 802, 804 to assemble and disassemble the modular node system 800, or for coupling and decoupling similar battery pack and sensor components 802, 804.

As shown in FIGS. 8A-8D, engagement mechanism 870 includes a central shaft or barrel portion 872 with top and bottom buttons or piston members 874A, 874B. The mechanism 870 may also be referred to as a pneumatic piston, stake, pin, shaft, or similar engagement member, configured to selectively engage and disengage the power module 802 and sensor module 804. For example, a pneumatic stake or pressure-actuated piston-type engagement member 870 can be coupled to the power module 802, and adapted for actuation via top and bottom pistons or pushbutton members 874A, 874B. In some embodiments, the top and bottom pistons or buttons 874A, 874B have a preselected or predefined geometric ratio suitably selected for mechanical advantage; e.g., with a diameter ratio of about 2:1, or an area ratio of about 4:1. An engagement member such as a tapered barrel or middle shaft portion 872 can be arranged to selectively engage the power source module 802 with the sensor module 804 when the pneumatic piston or shaft 870 is depressed; e.g., by engaging the shaft section 872 with a complementary slot, groove or similar feature 880 on the axial portion 842 of the sensor module 804, adjacent the axial connector 832.

Alternatively, one or more engagement mechanisms 870 can be provided on either or both of the power and sensor modules 802, 804, for engagement with the other of the power and sensor modules 804, 802. As shown in FIGS. 8A-8D, such mechanism 870 can also be configured to manually couple the power and sensor modules 802, 804 together in tool-less fashion, for example by pressing on or otherwise manipulating a shaft or pin member 870 in a vertical or axial direction (e.g., along the longitudinal direction of pin member 870), or by rotating member 870 about an axis. In these embodiments, the mechanism 870 can be manipulated from a first (disengagement) position to a second (engagement) position, where the tapered barrel or middle coupling portion 872 is engaged with a groove or slot 880 on the axial section 842 of the sensor module 804, or on or adjacent the connector 832. In some embodiments the connector 832 extend from the axial section 842 of the sensor module 804, and may be disposed between longitudinal sections of the power module 802, as described above. A suitable groove 880 can also be formed circumferentially about the perimeter of the axial section 842, or formed a slot located adjacent the shaft 872 of the coupling mechanism 870 when the power module 802 and sensor module 804 are fitted together.

In particular examples, the coupling mechanism 870 is disposed in, movably coupled to or otherwise mechanically associated with the power source module 802; e.g., with piston or manual button features 874A, 874B on one or both of the top and bottom ends of the central pin or shaft 872. In these embodiments, the tapered barrel or middle shaft portion 872 extends longitudinally between the transversely oriented button actuators or piston heads 874A, 874B on the top and bottom ends of the mechanism 870. The buttons or piston features 874A, 874B can be configured similarly or substantially identically, or they may be dissimilar, as described above. For example, a top button or piston feature 874A disposed on the upper end of the shaft 872 may have a diameter greater than that of the bottom button or piston feature 874B, on the lower end of the shaft 872.Depending on application, the diameter of the top feature 874A may be about one and a half times a great as the diameter of the bottom feature 874B, or about twice as great, about three or four times as great, or more or less. Alternatively the geometry of features 874A and 874B can be defined in terms of an area ratio of about 2:1 to about 10:1, or more or less, and the relative dimensions of the features 874A, 874B may be exchanged without loss of generality.

In the examples shown in FIGS. 8A-8D, the coupling mechanism 870 is configured for manipulation or actuation in a direction transverse to the major plane of the assembled module 800; e.g., for engagement between the shaft or barrel section 872 and a complementary grooved or slotted feature 880 formed in the axial section 842 of the sensor module 804, or on the connector 832. These examples are merely representative, and other coupling mechanisms 870 can be configured for axial, rotational, or sliding engagement between the power module 802 and the sensor module 804, with suitably adapted engagement and actuating features 872 and 874A, 874B, respectively. In additional embodiments, a suitable coupling mechanism 870 can be provided on either the sensor module 804 or on the power module 802, or both, similarly for the connector 832 and coupling features 880, in order to provide a complementary engagement structure for engaging the power module 802 and the sensor module 804.

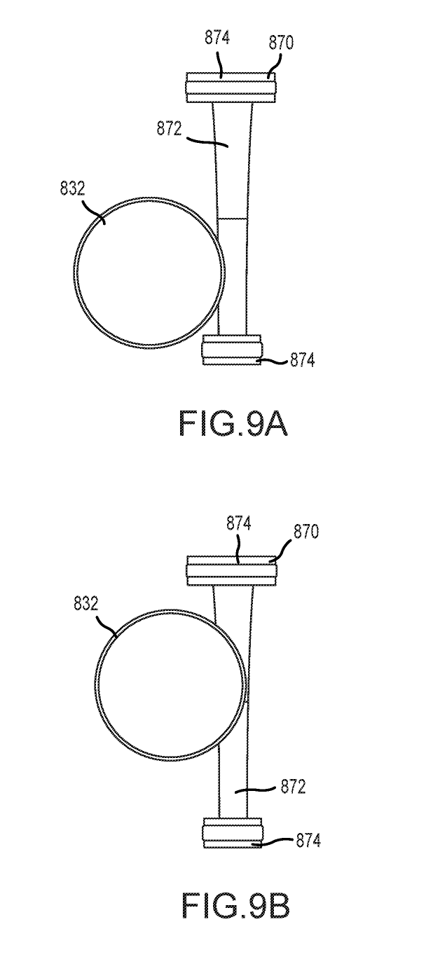

FIG. 9A is a side view of the coupling mechanism 870 in the first (disengaged) position. FIG. 9B is a side view of the coupling mechanism 870 in the second (engaged) position.

As shown in FIGS. 9A and 9B, the coupling mechanism 870 is axially manipulated to alternatively engage and disengage with connector 832 along a periphery thereof; e.g., with a groove, slot, or circumferential engagement feature 880. The barrel or middle section 872 of the coupling mechanism 870 can be tapered, with the taper adapted to alternatively disengage and engage the connector 832 in the first and second positions, respectively (or vice-versa, with the engaged and disengaged positions reversed).

To move the coupling mechanism 870 from its first position to its second position, the top actuator 874A can be operated in a first direction. For example, a user may depress the top button 874A to move the mechanism 870 axially downward until the tapered shaft or barrel section 872 engages with a complementary groove or slot 880 on the axial section 842 of the sensor module 804, or on the connector 832. Once the shaft 872 engages the coupling feature 880, the power and sensor modules 802, 804 are effectively secured together for deployment.

For disengagement of the power and sensor modules 802, 804, the mechanism 870 is moved from its second (engaged) position to its first (disengaged) position. The mechanism 870 can be pneumatically actuated using an internal or external pressure source, or a user may push the bottom button 874B on the lower end of the shaft 872. The mechanism 870 moves axially upward until the tapered shaft or barrel section 872 disengages from the slot or groove 880, at which point the power and sensor modules 802, 804 can be decoupled and disengaged by pulling or sliding the sensor module 804 away from the power module 802. Alternatively, a rotational coupling mechanism 870 can be provided, where the shaft 872 rotates about an axis to selectively disengage and engage the coupling feature 880. Suitable spring-biased, sliding, and other mechanical coupling mechanisms 870 can also be used, with coupling members 872 and engagement features 880 adapted accordingly, and with actuation features 874A, 874B configured for either manual or automatic operation.

### EXAMPLES

Suitable modular node devices may include one or more of a seismic node assembly, including a power source module, a sensor module, and a coupling therebetween. The power source module has first and second longitudinal sections extending from a base, at least one of the longitudinal sections having a power source disposed therein. The sensor module has an axial section configured for selective engagement between the first and second longitudinal sections of the power source module, the axial section having at least one seismic sensor disposed therein. The coupling is defined by the selective engagement between the power source module and the sensor module, where the at least one power source is electrically coupled to the at least one seismic sensor.

The axial section of the sensor module can be coaxially oriented along a principal axis of the seismic node assembly, with the first and second longitudinal sections of the power source module disposed laterally adjacent the axial section on opposing sides thereof, such that a center of mass of the seismic node assembly is disposed at a location of the at least one seismic sensor along the principal axis. The seismic node assembly can further include an acoustic transponder coupled to the sensor module, where the acoustic transponder is coaxially disposed with the axial section, along the principal axis.

At least one seismic sensor can have a particle motion sensor disposed within the axial section of the sensor module along a principal axis thereof, the principal axis extending longitudinally from a central portion of a frame member disposed transversely thereto. The seismic node assembly can also include at least one of a pressure sensor, a clock and a data recorder mounted to the transversely extending frame member, on a side opposite the axial section. A cover component can be coupled to the frame member on the side opposite the axial section, where the at least one of a pressure sensor, clock and data recorder is housed between cover and the frame member. The seismic node assembly can include first and second receiving structures coupled to the transversely extending frame member and extending longitudinally therefrom, the receiving structures configured to engage the first and second longitudinal sections of the power source module when engaged with the sensor module. The receiving structures can have sleeves configured to receive the longitudinal sections of the power source module therein.

The seismic node assembly can include a jacket coaxially disposed about the axial section of the sensor module and extending about the longitudinal sections of the power source module, where the jacket is configured to engage with the power source module and the sensor module to define a continuous outer surface of the seismic node assembly therebetween.

The seismic node assembly can include a connector extending longitudinally from the axial section of the sensor module along a principal axis thereof, the connector configured to form the coupling with a base member of the power source module, the base member extending transversely between the longitudinal sections.

The seismic node assembly can have a center of gravity that is disposed along a principal axis thereof, where the at least one seismic sensor is disposed about the center of gravity within the axial section of the sensor node, along the principal axis. The seismic node assembly can include an attachment system configured for coupling the seismic node assembly to a rope. The attachment system can have first and second modular, redundant coupling mechanisms for automatic engagement with opposing sides of a rope, where the engagement is responsive to detection of the rope between the engagement mechanisms.

Suitable power source module components include, but are not limited to, batteries, power supplies, and other power storage components, which can be electrically connected to the one or more seismic sensors to provide operational power when the sensor module and power supply module are engaged. In some embodiments, a memory board may be mounted between longitudinal sections of the power supply module. Suitable seismic sensor components include, but are not limited to, hydrophones, geophones, particle motion sensors, velocity sensors, accelerometers, and combinations thereof. One or more of a clock, data acquisition system and memory or data recording components can also be provided in the sensor module, with the memory or data recorder configured to store the seismic data together with associated timing data generated by the clock. In some embodiments, the memory board may be mounted on a base of the power module, between the longitudinal sections.

More generally, this application is also directed to a seismic survey apparatus including one or more modular seismic node systems, and methods for use of the apparatus in a seismic survey. Each node system may include individual power source and sensor modules. The sensor modules can include an elongate lobe or axial module extending from a base or frame component; e.g., with one or more seismic sensors configured to generate seismic data by sampling a seismic wavefield. The power module can include first and second elongate lobes or longitudinal sections extending from a second base or frame component; e.g., with one or more power source components configured to provide operational power to sensor module.

The sensor module can be configured to selectively couple to the power module; e.g., with the axial section disposed along a longitudinal axis of the node system and the longitudinal sections of the power module disposed on either side, in a plane generally parallel to the longitudinal axis. A wireless or acoustic transponder can also be provided for external communications; e.g., disposed along the longitudinal axis of the assembled seismic node system, in a coaxial arrangement with the axial section of the sensor module being disposed between the longitudinal sections of the power module.

When the modules are engaged, one or more power source components of the power module can be electrically connected to the seismic sensor; e.g., a hydrophone, geophone, multi-axis particle motion detector, or other scalar or vector instrument. One or more of a seismic data acquisition system, clock, transponder, and data storage or data recording components can also be provided with the sensor node system; e.g., disposed within the sensor module.

Suitable power source module components include, but are not limited to, batteries, power supplies, and other power storage components, which can be electrically connected to the one or more seismic sensors to provide operational power when the sensor module and power supply module are engaged. In some embodiments, a memory board may be mounted between longitudinal sections of the power supply module. Suitable seismic sensor components include, but are not limited to, hydrophones, geophones, particle motion sensors, velocity sensors, accelerometers, and combinations thereof. One or more of a clock, data acquisition system and memory or data recording components can also be provided in the sensor module, with the memory or data recorder configured to store the seismic data together with associated timing data generated by the clock. In some embodiments, the memory board may be mounted on a base of the power module, between the longitudinal sections.

More generally, this application is also directed to a seismic survey apparatus including one or more modular seismic node systems, and methods for use of the apparatus in a seismic survey. Each node system may include individual power source and sensor modules. The sensor modules can include an elongate lobe or axial module extending from a base or frame component; e.g., with one or more seismic sensors configured to generate seismic data by sampling a seismic wavefield. The power module can include first and second elongate lobes or longitudinal sections extending from a second base or frame component; e.g., with one or more power source components configured to provide operational power to sensor module.

The sensor module can be configured to selectively couple to the power module; e.g., with the axial section disposed along a longitudinal axis of the node system and the longitudinal sections of the power module disposed on either side, in a plane generally parallel to the longitudinal axis. A wireless or acoustic transponder can also be provided for external communications; e.g., disposed along the longitudinal axis of the assembled seismic node system, in a coaxial arrangement with the axial section of the sensor module being disposed between the longitudinal sections of the power module.

When the modules are engaged, one or more power source components of the power module can be electrically connected to the seismic sensor; e.g., a hydrophone, geophone, multi-axis particle motion detector, or other scalar or vector instrument. One or more of a seismic data acquisition system, clock, transponder, and data storage or data recording components can also be provided with the sensor node system; e.g., disposed within the sensor module.

Suitable methods of operating the seismic node system include methods for assembling and disassembling the power source and sensor modules. The method can include providing a power source module having first and second longitudinal sections extending from a base, where each of the longitudinal sections has a power source disposed therein, and coupling the power source module to a sensor module along a longitudinal axis thereof. The sensor module has an axial section disposed about the longitudinal axis and configured for selective engagement between the longitudinal sections of the power source module, where the axial section has at least one seismic sensor disposed therein, along the principal axis. The longitudinal sections of the power source module are symmetrically arranged about the longitudinal axis with the axial section of the sensor module disposed therebetween, such that a center of mass of the seismic node system substantially coincides with a position of the at least one seismic sensor along the longitudinal axis.

Suitable methods can also include attaching the seismic node system to a rope configured for deployment of the seismic node system to a water column. The method can also include operating the seismic node to acquire seismic data with the at least one seismic sensor, where the seismic data is responsive to a seismic wavefield propagating in the water column. Also, attaching the seismic node system can include automatically operating an attachment mechanism to receive the rope in response to sensing the rope adjacent thereto, and automatically engaging the rope with the engagement mechanism in response to receiving the rope therein.

Suitable modular node devices may include one or more modular seismic node, including a modular housing assembly that has a power source module and a sensor module. The power source module has first and second longitudinal sections extending longitudinally from a base. A power source is disposed within the power source module. The sensor module has an axial section extending longitudinally between the first and second longitudinal sections along a longitudinal axis. A seismic data recorder, a clock, a seismic sensor, a hydrophone, and a transponder are contained within the sensor module. The sensor module is configured to detachably couple to the power source module to electrically connect the power source to the seismic sensor. When coupled, the seismic node has a center of gravity extending along the longitudinal axis, and the transponder is arranged coaxially about the longitudinal axis.

The first and second longitudinal sections of the power source can be disposed laterally adjacent the axial section on opposing sides thereof, such that a center of mass of the seismic node assembly is disposed at a location of the at least one seismic sensor along the longitudinal axis. The sensor module can be configured to detachably couple to the power source module by sliding the axial section of the sensor module longitudinally between first and second longitudinal sections of the power source module. The first and second longitudinal sections of the power source module can be cylindrical. The axial section of the sensor module can be cylindrical. The module seismic node can include first and second receiving structures coupled to a frame member of the sensor module and extending longitudinally therefrom, where the receiving structures are configured to engage the first and second longitudinal sections of the power source module when engaged with the sensor module. The receiving structures can have sleeves configured to receive the longitudinal sections of the power source module therein.

In any of the above examples and embodiments, the seismic node assembly coupling can comprise an engagement member or mechanism movably coupled to one of the power source module and the sensor module; e.g., with the engagement mechanism adapted to selectively engage the other of the power source module and the sensor module upon manual manipulation. The engagement mechanism can comprise a pin structure or member having a tapered barrel portion adapted to selectively engage and disengage with a groove or slot defined on the axial section of the sensor module. Coupling the power source module to the sensor module can comprise selectively engaging such a pin or similar engagement member with the axial section of the sensor module. Selectively engaging the pin member with the axial section of the sensor module can comprise axially positioning a barrel or middle portion of the pin member within a groove or slot defined on a perimeter of the axial section of the sensor module. The engagement member can be movably coupled to the power source module and configured to selectively engage the axial section of the sensor module between the first and second longitudinal section of the power source module.

While this disclosure is directed to representative embodiments, other examples may be encompassed without departing from the scope of invention, as determined by the claims. While the invention may be described with respect to particular exemplary embodiments, it is understood that changes can be made and equivalents may be substituted to adapt the disclosure to different problems and application, while remaining within the spirit and scope of the invention as claimed. The invention is not limited to the particular examples that are described, but encompasses all embodiments falling within the scope of the claims.

1. A seismic node assembly comprising:
a power source module having a power source disposed therein;
a sensor module configured for selective engagement with the power source module, the sensor module having at least one seismic sensor disposed therein; and
a coupling defined by the selective engagement with the power source module and the sensor module, wherein the power source is electrically coupled to the at least one seismic sensor, and selectively decouplable therefrom.

2. The seismic node assembly of claim 1, further comprising:
at least first and second longitudinal sections extending from a base of the power source module, each of the longitudinal sections having a portion of the power source disposed therein; and
an axial section of the sensor module configured for selective engagement between the longitudinal sections of the power source module, wherein the at least one seismic sensor is disposed within the axial section, between the longitudinal sections.

3. The seismic node assembly of claim 2, wherein:
the axial section of the sensor module is oriented along an axis of the seismic node assembly with the first and second longitudinal sections of the power source module disposed laterally adjacent the axial section on opposing sides thereof, a center of gravity of the seismic node assembly being disposed along the axis; or
the at least one seismic sensor comprises a particle motion sensor disposed about a center of gravity of the seismic node assembly, within an axial section of the sensor module.

4. (canceled)

5. The seismic node assembly of claim 2, further comprising first and second receiving structures coupled to a transversely extending frame member of the sensor module and extending longitudinally therefrom, the receiving structures configured to engage the first and second longitudinal sections of the power source module when coupled to the sensor module.

6. The seismic node assembly of claim 1, further comprising one or more of:
a connector extending longitudinally from an axial section of the sensor module, the connector configured to form the coupling with a base member or chassis extending transversely between longitudinal sections of the power source module;
a cover component coupled to a frame or chassis of the sensor module on a side opposite the axial section, and at least one pressure sensor disposed between the cover and the frame or chassis; and
a jacket coaxially disposed about the axial section of the sensor module and extending about the longitudinal sections of the power source module, the jacket configured to engage between the power source module and the sensor module to define an outer surface of the seismic node assembly.

7-8. (canceled)

9. The seismic node assembly of claim 1, further comprising a coupling mechanism configured to mechanically engage the power source module with the sensor module, and to mechanically disengage the power source module from the sensor module, wherein the coupling mechanism comprises one or more of:
a shaft having a tapered section adapted to engage and disengage with a groove or slot defined on an axial section of the sensor module, the axial section being disposed between longitudinal sections of the power source module; or
a piston adapted for pneumatic actuation, manual actuation.

10. The seismic node assembly of claim 1, further comprising an attachment system adapted for coupling the seismic node assembly to a rope or cable, the attachment system having at least one capstan mechanism adapted to impart curvature to the rope or cable, wherein a load release tension for the rope or cable is maintained below a working limit based on the curvature.

11. The seismic node assembly of claim 1, further comprising an acoustic transponder configured for communication of control signals through a seismic medium to which the seismic node assembly is deployed, wherein:
the acoustic transponder is disposed in or on the sensor module, opposite the power source module along an axis of the seismic node assembly; or
the control signals comprise a mode signal adapted to switch the seismic node assembly between a power savings mode in which the sensor module operates in a reduced power state and an acquisition mode in which the sensor modules acquires the seismic data from the seismic medium.

12. The seismic node assembly of claim 11, further comprising a data acquisition system with a clock disposed within the sensor module and memory disposed within the power source module, wherein:
the data acquisition system is configured for collecting seismic data from the at least one seismic sensor and the memory is configured with capacity for storing the seismic data with an associated timing signal from the clock; or
the memory is configured for retrieving the seismic data with the power source module decoupled from the sensor module, and with the power source electrically decoupled from the data acquisition system.

13. (canceled)

14. The seismic node assembly of claim 12, further comprising a radio frequency or wireless transceiver provided on the seismic node assembly, the transceiver configured for synchronizing the clock for deployment of the seismic node assembly to a seismic medium.

15. A method for operating a seismic node, the method comprising:
providing a power source module having a power source disposed therein;
providing a sensor module having at least one seismic sensor disposed therein;
selectively engaging an axial section of the sensor module between longitudinal sections of the power source module, each of the longitudinal sections of the power source module housing a portion of the power source and the axial section housing the at least one seismic sensor, wherein the at least one seismic sensor is disposed along an axis of the axial section, between the longitudinal sections of the power source module; and
selectively coupling the power source module to the sensor module, wherein the power source is electrically coupled to the at least one seismic sensor, and selectively decouplable therefrom.

16. (canceled)

17. The method of claim 15, further comprising actuating a shaft or piston member adapted to mechanically engage and disengage the power source module with the sensor module, wherein the shaft or piston member is manually or pneumatically actuated, or both.

18. The method of claim 15, further comprising attaching the seismic node to a rope or cable configured for deployment to a water column, and:
maintaining a load release tension for the rope or cable below a working limit based on curvature of the rope or cable by a capstan mechanism engaged thereto; or
sensing the rope or cable adjacent to the seismic node, and automatically engaging the rope or cable in response thereto.

19. The method of claim 15, further comprising operating the seismic node to acquire seismic data with the at least one seismic sensor, the seismic data responsive to a seismic wavefield propagating in a seismic medium to which the seismic node is deployed, and:
acquiring the seismic data with a data acquisition system, associating the seismic data with a clock signal from a clock, and storing the seismic data with the associated clock signal in memory disposed in the power source module;
decoupling the power source module from the sensor module and retrieving the seismic data from the memory, wherein the power source is electrically decoupled from the data acquisition system and clock when the seismic data are retrieved; or
synchronizing the clock signal via a wireless receiver disposed on the seismic node

20-22. (canceled)

23. The method of claim 19, further comprising communicating control information for operation of the seismic node to acquire the seismic data, wherein:
the control information is communicated through the seismic medium via an acoustic transponder disposed on the seismic node; or
the control information comprises a mode signal adapted to switch the seismic node assembly between a power savings mode in which the sensor module operates in a reduced power state and an acquisition mode in which the sensor module acquires the seismic data.

24. A modular seismic node according to the assembly of claim 1, and further comprising:
a modular housing assembly comprising the power source module and the sensor module;
at least first and second longitudinal sections extending longitudinally from a base of the power source module, each of the longitudinal sections housing a portion of the power source; and
an axial section extending axially from a base of the sensor module, the axial section of the sensor module housing the at least one seismic sensor between the longitudinal sections of the power source module;
wherein the sensor module is configured to detachably couple to the power source module to electrically connect the power source to the seismic sensor.

25. (canceled)

26. The seismic node of claim 24, wherein:
the longitudinal sections of the power source module are disposed laterally adjacent the axial section of the sensor module on opposing sides thereof, with the at least one seismic sensor located about a center of gravity of the modular seismic node; and
the sensor module configured is configured to detachably couple to the power source module by engaging the axial section of the sensor module between the longitudinal sections of the power source module, and
further comprising receiving structures coupled to the sensor module and extending longitudinally therefrom to engage the longitudinal sections of the power source module when coupled to the sensor module.

27. (canceled)

28. The seismic node of claim 24, further comprising a coupling mechanism comprising a piston or shaft configured to mechanically engage the power source module with the sensor module, wherein the piston or shaft is adapted for manual actuation, pneumatic actuation, or both.

29. The seismic node of claim 24, further comprising:
a data acquisition system and clock disposed within the sensor module, the data acquisition system configured for collecting seismic data from the at least one seismic sensor and the clock configured for associating the seismic data with a clock signal; and
memory disposed within the power source module, the memory having capacity for storing the seismic data associated with the clock signal;
wherein the memory is configured for retrieving the seismic data from the memory with the power source module decoupled from the sensor module, such that the power source is electrically decoupled from the data acquisition system and the clock when the seismic data are retrieved.

30. (canceled)

31. The seismic node of claim 29, further comprising a pressure transducer configured to determine a depth of the modular seismic node within a water column, wherein a preselected threshold depth is defined for selectively operating the data acquisition system in a low power mode until the threshold depth is reached, and for switching the data acquisition system to an active mode for seismic data acquisition when the threshold depth is reached.

32. The seismic node of claim 24, further comprising a transponder configured to transmit and receive control communications for the seismic node with the modular seismic node deployed in a water column, wherein:
the transponder is arranged along a longitudinal axis defined through an axial section of the sensor module; or
the control communications comprise a control signal adapted to switch the seismic node between a power savings mode in which the sensor module operates in a reduced power state and an acquisition mode in which the sensor modules acquires seismic data from the water column.

33. A modular seismic node configured for deployment to a seismic medium, the modular seismic node comprising:
at least one seismic sensor adapted to acquire seismic data from the seismic medium;
a clock adapted to provide clock signals associated with the seismic data;
at least one power source adapted for powering the at least one seismic sensor and clock;
memory with capacity for storing the seismic data and associated clock signals;
an acoustic transponder adapted for communicating command signals to the seismic node through the seismic medium, the seismic node being deployed thereto; and
a wireless transmitter adapted for one or both of:
synchronizing the clock prior to or upon deployment to the seismic medium, and reading the clock prior to or upon recovery from the seismic medium;
wherein the command signals are adapted to switch the seismic node between a power savings mode in which the seismic node operates in a reduced power state and an acquisition mode in which the seismic node acquires the seismic data and stores the seismic data and associated clock signals in the memory.

34. (canceled)

35. The modular seismic node of claim 33, further comprising:
a single housing for the at least one seismic sensor, the clock, the at least one power source and the memory, wherein the acoustic transponder and wireless transmitter are coupled to the single housing; or
a sensor module housing the at least one seismic sensor and clock, a power source module housing the at least one power source and memory, and a coupling mechanism configured to selectively engage and disengage the power source module with the sensor module, wherein the coupling mechanism comprises a piston or shaft adapted to engage and disengage the power source module with the sensor module.
